(19) United States
(12) Patent Application Publication
(10) Pub. No.: US 2025/0161730 A1
(43) Pub. Date: May 22, 2025

(54) BATTERY PACK WITH CONDITION-SENSITIVE MEMBRANES

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 18/839,981

(22) PCT Filed: Feb. 23, 2023
(86) PCT No.: PCT/US2023/013734

§ 371 Date: Aug. 20, 2024

Related U.S. Application Data
(60) Provisional application No. 63/323,643, filed on Mar. 25, 2022.

(51) Int. Cl. A62C 3/16; B60L 50/64; H01M 50/249; H01M 50/342; H01M 50/673

(52) U.S. Cl. CPC A62C 3/16; H01M 50/249; H01M 50/3425; H01M 50/673; B60L 50/64; H01M 2220/20

(57) ABSTRACT

A battery system including a housing defining an aperture and an internal volume, a battery section contained within the internal volume, and a seal coupled to the housing and reconfigurable from a sealed state to a ruptured state in response to a predetermined condition within the housing. In the sealed state, the seal prevents fluid from flowing through the aperture. In the ruptured state, the seal permits the fluid to flow through the aperture.

### CROSS-REFERENCE TO RELATED PATENT APPLICATION

This application claims the benefit of and priority to U.S. Provisional Application No. 63/323,643, filed on Mar. 25, 2022, the entire disclosure of which is hereby incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

At least one embodiment relates to a battery system including a housing defining an aperture and an internal volume, a battery section contained within the internal volume, and a seal coupled to the housing and reconfigurable from a sealed state to a ruptured state in response to a predetermined condition within the housing. In the sealed state, the seal prevents fluid from flowing through the aperture. In the ruptured state, the seal permits the fluid to flow through the aperture.

Another embodiment relates to a battery system including a housing a housing defining a first aperture, a second aperture, and an internal volume, the first aperture and the second aperture being in fluid communication with the internal volume, a battery section contained within the internal volume, a first seal coupled to the housing and extending across the first aperture, and a second seal coupled to the housing and extending across the second aperture. The first seal is configured to rupture in response to exposure to an acid to permit flow through the first aperture. The second seal is configured to rupture in response to exceeding a threshold temperature to permit flow through the second aperture.

Another embodiment relates to a battery system including a housing defining an internal volume, a battery cell, a fire suppressant supply configured to provide a fire suppressant, and a seal positioned to fluidly decouple the fire suppressant supply from the internal volume. The seal is configured to rupture in response to contact with a substance released by the battery cell to permit the fire suppressant to enter the internal volume.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a schematic diagram of configuration of the battery system of FIG. 1, according to an exemplary embodiment.

FIG. 6 is a section view of a seal assembly of the battery system of FIG. 5.

FIG. 7 is a schematic diagram of a seal of the battery system of FIG. 5, according to an exemplary embodiment.

FIG. 8 is a schematic diagram of a seal of the battery system of FIG. 5, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a battery system is shown according to an exemplary embodiment. The battery system includes a battery pack and a fire suppression system that is configured to address fires within the battery pack. A housing of the battery pack defines a series of housing apertures that are utilized during a thermal event or hazard event, such as a fire or overheating of the battery cells. During a thermal event, fire suppressant is introduced into the housing through suppressant apertures defined by the housing. Additionally, a series of vent apertures defined by the housing permit gases produced by overheating battery cells to exit the battery pack and pass into the surrounding atmosphere. The vent apertures may also permit fire suppressant to exit the battery pack, preventing over pressurization of the battery pack.

During normal operation and when the battery system is inactive, it is beneficial to seal the inside of the housing to prevent ingress of debris (e.g., dust, insects, etc.), moisture, or other contaminants. While beneficial during a thermal event, the housing apertures provide passages through which such contaminants can enter the housing. To prevent this, the battery system utilizes condition-sensitive membranes that extend over the housing apertures, forming a seal to prevent contaminants from entering the housing. The membranes are configured to rupture in response to certain conditions, breaking the seal. By way of example, a membrane may rupture over a suppressant aperture to permit suppressant to enter the housing. By way of another example, a membrane may rupture over a vent aperture to permit gases or suppressant to exit the housing.

The membranes may be pressure-sensitive membranes that rupture when experiencing an elevated pressure. Such a pressure-sensitive membrane may rupture in response to contact with pressurized suppressant or in response to the gases within the housing building in pressure. The membranes may be configured to rupture in response to an elevated temperature (e.g., indicative of a fire or thermal runaway of a battery cell) or contact with certain chemicals (e.g., chemicals released by a battery cell during thermal runaway). The membranes may be configured to rupture in response to a signal from a controller of the battery system.

### System Overview

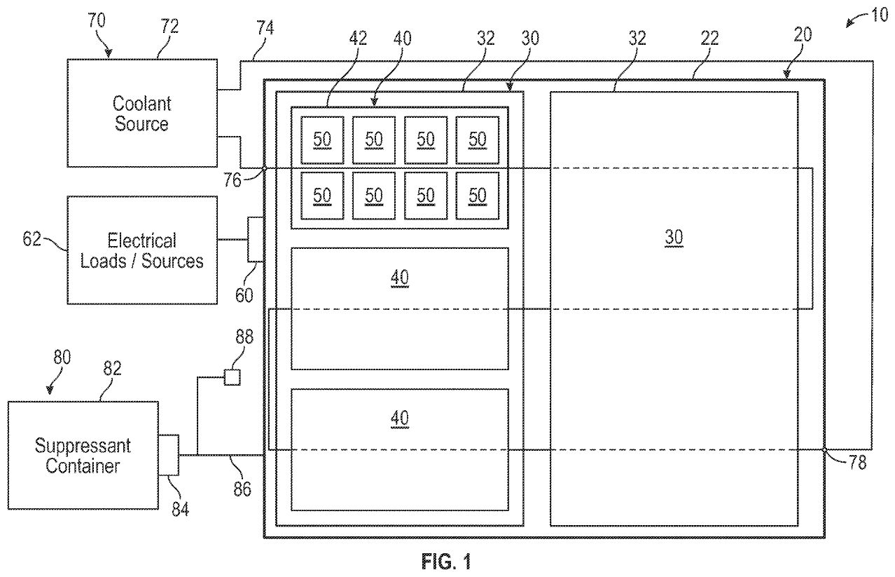

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

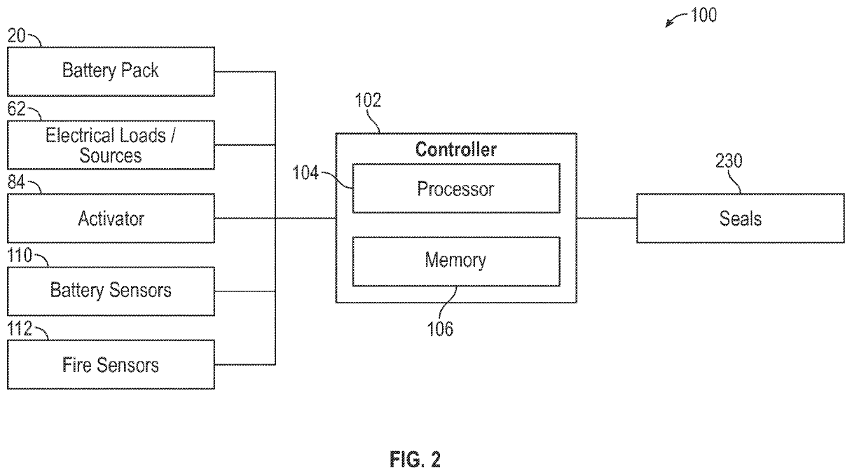

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

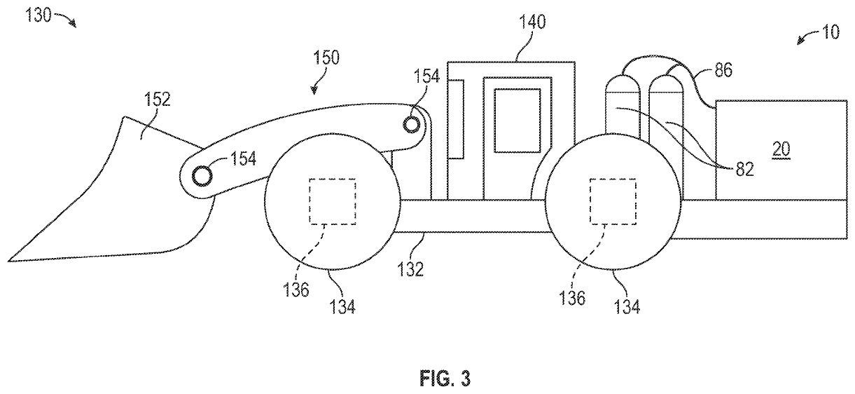

Referring to FIG. 3, a vehicle 130 is equipped with the system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

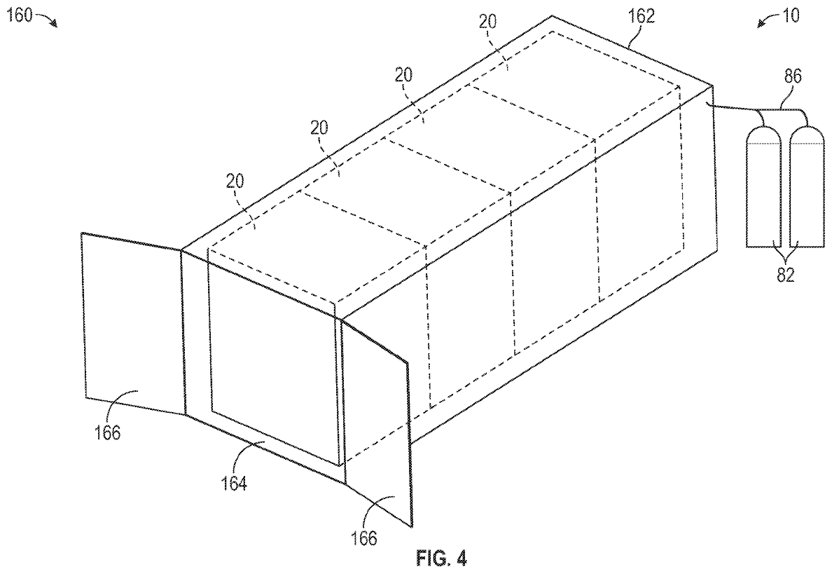

Referring to FIG. 4, a containerized energy storage system, shown as container system 160, is equipped with the system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

Battery Pack with Condition-Sensitive Membranes

In some other systems, mechanisms for agent release used when controlling Li-Ion battery fires rely on a battery management system (BMS) for dispersal. According to an exemplary embodiment, a system eliminates the concern over potential BMS failure by creating either an agent release mechanism or venting mechanism that is not reliant on BMS hazard detection. An opening for either venting or agent release is covered with a condition-sensitive coating which would rupture upon exposure to a condition indicative of to a hazard event. By way of example, the coating may be a pressure-sensitive coating that ruptures in response to an increase in pressure caused by a hazard event. Alternatively the condition-sensitive coating could be ruptured in response to a signal from a functional BMS, which would detect the condition (e.g., increased pressure) in the battery as a sign of potential failure. Advantageously, the condition-sensitive coating keeps the stored firefighting agent free from on-site contamination. Additionally, the condition-sensitive coating provides a redundant operating mechanism in case the BMS is malfunctioning or inoperable. If used as a vent, the coating prevents over pressurization of a battery system caused by firefighting agent application.

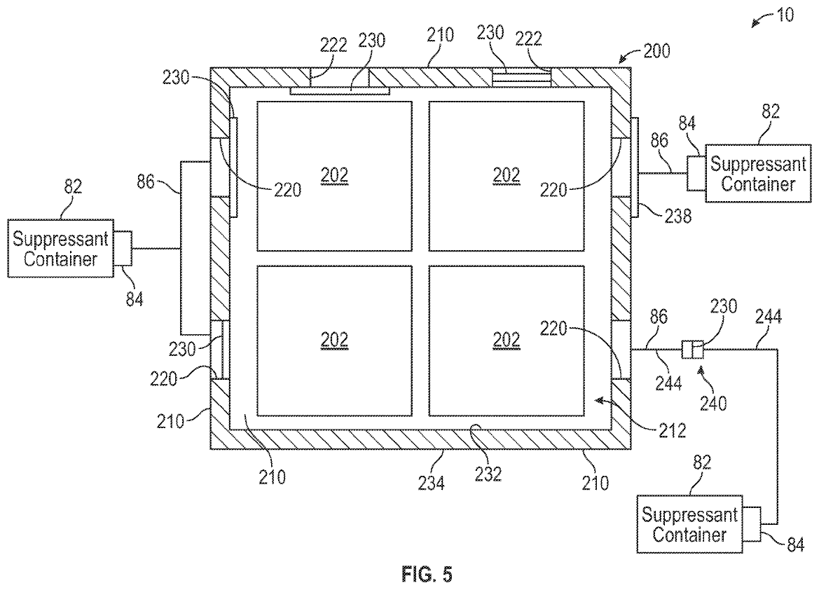

Referring to FIG. 5, a configuration of the system 10 is shown according to an exemplary embodiment. In this embodiment, a housing 200 is shown according to an exemplary embodiment. The housing 200 contains a series of battery sections 202. The configuration of the housing 200 shown in FIG. 5 may be utilized at the battery module 40 level, the subpack 30 level, and/or the battery pack 20 level. The housing 200 may be the pack housing 22 of the battery pack 20, and the battery sections 202 may represent the subpacks 30 within the pack housing 22. The housing 200 may be the housing 32 of one of the subpacks 30, and the battery sections 202 may represent the battery modules 40 within the housing 32. The housing 200 may be the housing 42 of one of the battery modules 40, and the battery sections 202 may represent the battery cells 50 within the housing 42. Accordingly, any description of the housing 200 may apply to the pack housing 22, the housings 32, and/or the housings 42. Similarly, any description of the battery sections 202 may apply to the subpacks 30, the battery modules 40, and/or the battery cells 50.

The housing 200 includes structures or housing walls, shown as walls 210, defining an internal volume 212 of the housing 200. The internal volume 212 contains the battery sections 202. Accordingly, the walls 210 surround the battery sections 202. As shown, the walls 210 are generally rectangular, such that the housing 200 is generally shaped as a rectangular prism. In other embodiments, the housing 200 is otherwise shaped (e.g., as a cylinder, as a sphere, as a triangular prism, as a frustoconical shape, etc.).

The walls 210 form a series of passages or housing apertures (e.g., the suppressant apertures 220 and the vent apertures 222). The housing apertures extend through the walls 210 to fluidly couple with the internal volume 212. The housing aperture permit the passage of material into and/or out of the internal volume 212. It should be understood that the quantity and position of housing apertures shown in FIG. 5 are provided by way of example, and the housing 200 may define a different quantity and/or position of the housing apertures.

The housing apertures include one or more inlets or inlet passages, shown as suppressant apertures 220. The suppressant apertures 220 are configured to introduce fire suppressant into the internal volume 212. As shown in FIG. 5, the suppressant apertures 220 are each coupled to a suppressant container 82 by a conduit of a distribution network 86. In the arrangement on the left side of FIG. 5, one suppressant container 82 is fluidly coupled to two of the suppressant apertures 220 in parallel. In the arrangements on the right side of FIG. 5, two suppressant apertures 220 are provided, and each suppressant aperture 220 is fluidly coupled to a separate suppressant container 82. In operation, fire suppressant is released from a suppressant container 82 by a corresponding activator 84, and the fire suppressant passes through the distribution network 86, through the corresponding suppressant aperture 220 or suppressant apertures 220, and into the internal volume 212. Once inside of the internal volume, the suppressant can reach the battery sections 202 to address any fires or potential fires within the internal volume 212.

The housing apertures further include one or more outlets or outlet passages, shown as vent apertures 222. The vent apertures 222 are configured to permit gases to exit the internal volume 212, moving the gases away from the battery sections 202 and out into the surroundings. During a thermal event, the battery cells 50 may produce combustible gases. It is advantageous to permit these gases to escape the housing 200, as this moves the gases away from potential ignition sources (e.g., a shorted battery connection, a battery cell 50 at an elevated temperature, etc.). Accordingly, the vent apertures 222 may help prevent combustion of the gases. Additionally, the vent apertures 222 may permit a portion of the fire suppressant from the suppressant containers 82 to exit the internal volume 212. The vent apertures 222 may prevent the pressure within the internal volume 212 from exceeding a threshold pressure that could otherwise cause damage to the battery sections 202.

The system 10 includes a series of condition-sensitive membranes, coatings, or seals, shown as seals 230. The seals 230 are reconfigurable from an intact or sealing configuration or sealed state to a broken, free-flowing, or ruptured configuration or ruptured state by puncturing, tearing, bursting, or otherwise rupturing the seals 230. The seals 230 are each fluidly coupled to one or more of the housing apertures. In the sealing configuration, each seal 230 prevents flow through the corresponding housing aperture, fluidly decoupling the internal volume 212 from the surroundings of the housing 200. Beneficially, the seals 230 in the sealed configuration prevent contaminants (e.g., dust, insects, moisture, air, etc.) from entering the internal volume 212 and contaminating the battery sections 202. In the ruptured configuration, the seal 230 permits free flow through the corresponding housing aperture, fluidly coupling the internal volume 212 to the surrounding environment and/or the suppression system 80. The ruptured configuration may be used during a thermal event to permit fire suppressant to enter the internal volume 212 and/or to permit gases and/or excess fire suppressant to exit the internal volume 212. Accordingly, the seals 230 prevent contamination of the internal volume 212 and the components therein without hindering performance of the suppression system 80 during a thermal event.

In some embodiments, the seals 230 are arranged to seal the suppressant apertures 220. Specifically, in the sealing state, the seals 230 fluidly decouple the distribution network 86 from the internal volume 212. When ruptured, the seals 230 permit the suppressant apertures 220 to fluidly couple the internal volume 212 to the distribution network 86. When suppressing a fire, the fire suppressant flows from the suppressant container 82, through the distribution network 86, the ruptured seal 230, and the corresponding suppressant aperture 220, and into the internal volume 212.

In some embodiments, the seals 230 are arranged to seal the vent apertures 222. Specifically, in the sealing state, the seals 230 fluidly decouple the internal volume 212 from the surroundings of the housing 200. When ruptured, the seals 230 permit the vent apertures 222 to fluidly couple the internal volume 212 to the surroundings of the housing 200. During a thermal event, gas and/or excess fire suppressant is permitted to flow from the internal volume 212, through the vent apertures 222, and into the surroundings of the housing 200.

The seals 230 may have various positions relative to the walls 210. As shown, each wall 210 includes an internal surface 232 facing toward the internal volume 212, and an external surface 234 facing outward, away from the internal volume 212. In some embodiments, the seal 230 is positioned between the internal surface 232 and the external surface 234, entirely within the housing aperture. In some embodiments, the seal 230 extends along the internal surface 232. In some embodiments, the seal 230 extends along the external surface 234. The seals 230 may be fixedly coupled to the walls 210 using adhesive, fasteners, or another type of coupler.

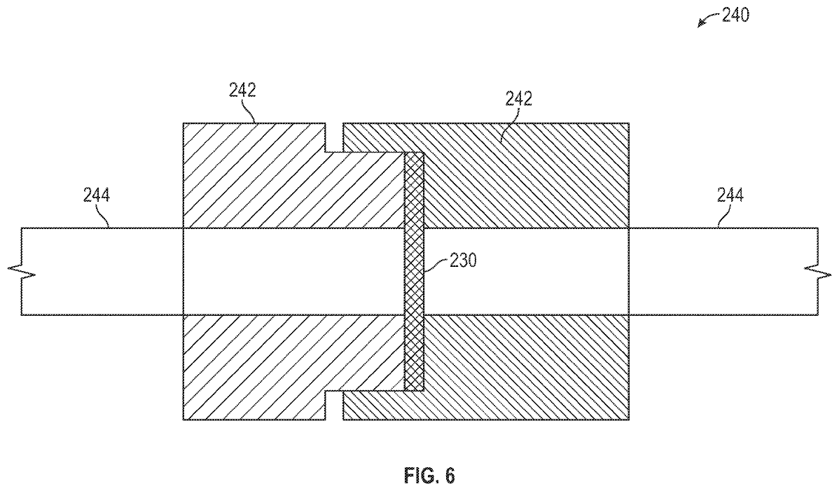

In some embodiments, the seal 230 is in fluid communication with one of the suppressant apertures 220 or the vent apertures 222, but is not directly coupled to the walls 210 of the housing 200. By way of example, FIGS. 5 and 6 illustrate a seal assembly 240 positioned along the distribution network 86, between a suppressant container 82 and a suppressant aperture 220. The seal assembly 240 includes housing portions 242 that are selectively coupled to one another (e.g., through a threaded connection). Each housing portion 242 is fluidly coupled to a conduit 244 (e.g., a hose, a pipe, a tube, etc.) of the distribution network 86, such that the seal assembly 240 is fluidly coupled in series with the distribution network 86. One of the conduits 244 is fluidly coupled to a suppressant aperture 220, and the other of the conduits 244 is fluidly coupled to the suppressant container 82 through the activator 84. The seal 230 is positioned between the housing portions 242, such that the seal 230 is positioned between the conduits 244. In the sealing state, the seal 230 prevents fluid flow between the conduits 244. In the ruptured state, the seal 230 permits fluid flow between the conduits 244.

The seal 230 may be made from a variety of different materials. In some embodiments, the seal 230 is made from a polymer, such as rubber or plastic. In some embodiments, the seal 230 is made from a metal (e.g., stainless steel, carbon steel, aluminum, etc.). In some embodiments, the seal 230 is a rupture disc or burst disc.

In some embodiments, the seals 230 are sensitive to certain predetermined conditions. Specifically, the seals 230 may be configured to rupture (i.e., change from the sealing configuration to the ruptured configuration) in response to a predetermined condition. In some embodiments, the seals 230 are pressure-sensitive seals that are configured to rupture based on a pressure experienced by the seal 230. In some embodiments, the seals 230 are heat-sensitive seals that are configured to rupture based on a temperature experienced by the seal 230. In some embodiments, the seals 230 are chemically-sensitive seals that are configured to rupture based on exposure to a specific chemical or substance. Beneficially, the conditions that cause the seals 230 to rupture may be selected to cause a desired response of the system 10 during a thermal event.

### A. Pressure-Sensitive Seals

In some embodiments, the seals 230 are pressure-sensitive seals that are configured to rupture based on a pressure experienced by the seal 230. In some embodiments, one or more of the seals 230 are configured to rupture in response to a pressure differential across the seal 230 (e.g., a difference between a pressure on a first side of the seal 230 and a pressure on the opposite, second side of the seal 230) exceeding a threshold pressure. This threshold pressure may be selected when designing the system 10. By way of example, the threshold pressure may be varied by varying the material of the seal 230, the size of the seal 230, by adding perforations, ribs, or other shapes to the seal 230, etc.

In some embodiments, the threshold pressure is selected such that a seal 230 over a suppressant aperture 220 ruptures in response to fire suppressant being supplied by the suppression system 80. By way of example, a suppressant container 82 may store fire suppressant at an elevated pressure (e.g., above atmospheric pressure). When released from the suppressant container 82, the fire suppressant may move along the distribution network 86 to the seal 230. The threshold pressure may be selected such that the pressure of the fire suppressant when the fire suppressant has reached the seal 230 is sufficient to rupture the seal 230. This configuration may be beneficial, as the fire suppressant may automatically rupture the seal when the suppression system 80 is activated.

In some embodiments, the threshold pressure is selected such that a seal 230 over a suppressant aperture 220 ruptures in response to a buildup of pressure within the housing 200. By way of example, during a thermal event, the battery cells 50 may produce a gas, which fills the internal volume 212. As the gas is produced, the pressure within the housing 200 increases. Once this pressure of the internal volume 212 reaches a threshold pressure, the seal 230 ruptures, fluidly coupling the internal volume 212 to the distribution network 86. In some such embodiments, the seal 230 acts as the activator 84, initiating dispensing of the fire suppressant into the internal volume 212 when the seal 230 ruptures. By way of example, the suppressant container 82 may be constantly fluidly coupled to the distribution network 86 such that the fire suppressant is in contact with the seal 230 during a normal operating state of the system 10. When a thermal event occurs and the pressure within the housing 200 becomes elevated sufficiently to rupture the seal 230, the fire suppressant is free to enter the internal volume 212. Beneficially, this type of activation requires no active input from the controller 102, such that the suppression system 80 can be activated to address a fire within the battery pack 20 even if the controller 102 were malfunctioning or inoperable.

In some embodiments, the threshold pressure is selected such that a seal 230 over a vent aperture 222 ruptures in response to a buildup of pressure within the housing 200. By way of example, during a thermal event, the battery cells 50 may produce a gas, which fills the internal volume 212. As the gas is produced, the pressure within the housing 200 increases. Once this pressure of the internal volume 212 reaches a threshold pressure, the seal 230 ruptures, permitting the gas to exit the internal volume 212 through the vent aperture 222. This may be beneficial, as the gases produced by the battery cells 50 may be combustible. By way of another example, fire suppressant supplied to the internal volume 212 may increase the pressure within the housing 200. If this causes the seal 230 to exceed the threshold pressure, the seal 230 may rupture to permit a portion of the fire suppressant to exit the housing 200. This may prevent the pressurized fire suppressant from damaging one or more pressure-sensitive components of the battery pack 20 (e.g., the battery cells 50). Beneficially, this type of pressure relief requires no active input from the controller 102, such that the housing 200 can release the gasses and/or fire suppressant even if the controller 102 were malfunctioning or inoperable.

In some embodiments, the seals 230 over the vent apertures 222 are configured to rupture at a different threshold pressure than the seals 230 over the suppressant apertures 220. By way of example, the seals 230 over the vent apertures 222 may have a lower threshold pressure than the seals 230 over the suppressant apertures 220. This may permit the seals 230 over the vent apertures 222 to rupture before the seals 230 over the suppressant apertures 220, such that gas generated within the housing 200 can be vented without fluidly coupling the internal volume 212 to the suppressant container 82.

### B. Heat-Sensitive Seals

In some embodiments, the seals 230 are heat-sensitive or temperature-sensitive seals that are configured to rupture based on a temperature experienced by the seal 230. By way of example, the seals 230 may rupture (e.g., melt) in response to reaching a threshold temperature. This increase in temperature may indicate a fire or malfunctioning battery cell 50 within the housing 200. In some embodiments, the threshold temperature is selected such that the seals 230 will not rupture in response to temperatures that are experienced during normal operation of the battery pack 20. Beneficially, a temperature-sensitive seal 230 requires no active input from the controller 102, such that the seal 230 can respond to a thermal event even if the controller 102 is malfunctioning or inoperable.

In some embodiments, the threshold temperature is selected such that a seal 230 over a suppressant aperture 220 ruptures in response to a thermal event that is in sufficiently close proximity to raise the temperature of the seal 230. In some such embodiments, the seal 230 acts as the activator 84, initiating dispensing of the fire suppressant into the internal volume 212 when the seal 230 ruptures. By way of example, the suppressant container 82 may be constantly fluidly coupled to the distribution network 86 such that the fire suppressant is in contact with the seal 230 during a normal operating state of the system 10. When a thermal event occurs and the temperature within the housing 200 becomes elevated sufficiently to rupture the seal 230, the fire suppressant is free to enter the internal volume 212.

In some embodiments, the threshold temperature is selected such that a seal 230 over a vent aperture 222 ruptures in response to a thermal event that is in sufficiently close proximity to raise the temperature of the seal 230. This may release gasses produced by a malfunctioning battery cell 50 from the housing 200.

In some embodiments, the seal 230 is formed from a heat-sensitive polymer or polymer blend. The polymer or polymer blend may be configured to degrade (e.g., melt, burn, sublimate, etc.) in response to exposure to the threshold temperature. The specific type of polymer or polymer blend may determine the threshold temperature. By way of example, the seal 230 may include nylon, polystyrene, polymethyl methacrylate, polyolefins, and/or other types of polymers.

### C. Chemically-Sensitive Seals

In some embodiments, the seals 230 are chemically-sensitive seals that are configured to rupture based on exposure to a specific chemical or substance. By way of example, the seals 230 may rupture (e.g., dissolve, burn, sublimate, etc.) in response to exposure with a substance that is produced by or released from a malfunctioning battery cell 50. By way of example, the seals 230 may rupture in response to exposure to a gas produced by a battery cell 50 during a thermal event. By way of another example, the seals 230 may rupture in response to exposure to a chemical contained within a battery cell 50 (e.g., indicating that one or more of the battery cells 50 is no longer sealed). The presence of such substances may be indicative of a thermal event, such that the seals 230 automatically respond to thermal events. Beneficially, a chemically-sensitive seal 230 requires no active input from the controller 102, such that the seal 230 can respond to a thermal event even if the controller 102 is malfunctioning or inoperable.

In some embodiments, the chemical required to rupture the seal 230 is selected such that a seal 230 over a suppressant aperture 220 ruptures in response to malfunctioning of a nearby battery cell 50. In some such embodiments, the seal 230 acts as the activator 84, initiating dispensing of the fire suppressant into the internal volume 212 when the seal 230 ruptures. By way of example, the suppressant container 82 may be constantly fluidly coupled to the distribution network 86 such that the fire suppressant is in contact with the seal 230 during a normal operating state of the system 10. When a thermal event occurs and the chemical is released by the battery cell 50, coming into contact with the seal 230, the fire suppressant is free to enter the internal volume 212.

In some embodiments, the chemical required to rupture the seal 230 is selected such that a seal 230 over a vent aperture 222 ruptures in response to malfunctioning of a nearby battery cell 50. This may release gasses produced by the malfunctioning battery cell 50 from the housing 200.

In some embodiments, the seal 230 is formed from an acid-sensitive material or blend of materials. The material may be configured to degrade (e.g., melt, burn, sublimate, etc.) in response to exposure to an acidic material (e.g., from a battery cell). The specific type of material or material blend may determine the acidity (e.g., a threshold pH level) of the material required to rupture the seal 230 (e.g., the acid sensitivity of the seal 230). In some embodiments, the seal 230 is formed from an acid-sensitive polymer or blend of polymers. By way of example, the seal 230 may include polyethylene, cellulose acetate, and/or other types of polymers. In some embodiments, the seal 230 is formed from an acid-sensitive inorganic material or blend of inorganic materials. By way of example, the seal 230 may include calcium carbonate, potassium carbonate, and/or other inorganic materials.

### D. Controller-Operated Seals

In some embodiments, the seals 230 are operatively coupled to the controller 102 (e.g., as shown in FIG. 2), such that the seals 230 can be ruptured in response to a signal (e.g., a command) from the controller 102. Such signal-activated seals 230 may also be pressure-sensitive, temperature-sensitive, and/or chemically-sensitive, such that the seal 230 may rupture automatically in response to an environmental condition or in response to a signal from the controller 102. By way of example, the controller 102 may send an electronic signal to an actuator that mechanically punctures a seal 230 (e.g., using a sharpened puncturing rod that is coupled to a solenoid, etc.). The controller 102 may provide a signal to rupture a seal 230 in response to a detection or prediction of a fire (e.g., through the battery sensors 110, through the thermal event sensors 112, etc.).

In some embodiments, the temperature-sensitive and chemically-sensitive seals 230 can provide a localized distribution of fire suppressant based on the location of a thermal event within the internal volume 212. During a thermal event, a malfunctioning battery section 202 (e.g., a battery cell 50) releases thermal energy and chemicals into an area (e.g., a portion of the internal volume 212) nearby the battery section 202. As the effect of the malfunctioning battery section 202 extends farther from the battery section 202, the concentration of the released thermal energy and chemicals decreases. Accordingly, seals 230 nearby the malfunctioning battery section 202 may experience sufficient temperature increases and/or concentrations of chemicals to rupture, whereas seals farther from the malfunctioning battery section 202 may not. This causes a localized response of the suppression system 80, such that fire suppressant is distributed in a first area nearby the malfunctioning battery section 202, but fire suppressant is not distributed in a second area farther from the malfunctioning battery section 202.

Similarly, the signal-activated seals 230 can provide a localized distribution of fire suppressant based on the location of a thermal event within the internal volume 212. The controller 102 may determine the location of a thermal event (e.g., using data from the battery sensors 110 and/or the thermal even sensors 112). The controller 102 may then activate (e.g., provide signals that cause the rupture of) the seals 230 closest to the determined location of the thermal event.

In the example illustrated in FIG. 5, two seals 230 are each fluidly coupled to the same suppressant container 20. A first seal 230 (e.g., the upper seal 230 along the left side of the housing 200) is positioned adjacent a first area that contains a first battery section 202. A second seal 230 (e.g., the lower seal 230 along the left side of the housing 200) is positioned adjacent a second area that contains a second battery section 202. If the first battery section 202 were to malfunction, the first seal 230 would rupture (e.g., due to the thermal energy or chemicals released by the first battery section 202) and dispense fire suppressant nearby the first battery section 202, while the second seal 230 would remain sealed. Similarly, if the second battery section 202 were to malfunction, the second seal 230 would rupture and dispense fire suppressant nearby the second battery section 202, while the first seal 230 would remain sealed. Accordingly, a single suppressant container 82 can address fires within multiple areas of the internal volume 212 without having to be sized to supply fire suppressant to all of the areas simultaneously.

### E. Seals Responsive to Multiple Conditions

In some embodiments, the seals 230 of the system 10 are responsive to multiple conditions. In some such embodiments, the housing 200 is outfitted with two or more seals 230 configured to rupture in response to different conditions. Specifically, one or more first apertures (e.g., suppressant apertures 220, vent apertures 222, etc.) may each be outfitted with a seal 230 that ruptures in response to a first condition, and one or more second apertures may each be outfitted with a seal 230 that ruptures in response to a second, different condition. In this way, the type of seal 230 used may vary throughout the housing 200 based on the most likely mode of failure in that area. By way of example, a first area of the housing 200 may include seals 230 that are temperature-sensitive, and another area of the housing 200 may include seals 230 that are pressure-sensitive. In such an example, the temperatures-sensitive seals 230 may be positioned in areas along the top of the housing 200 to most effectively respond to heated materials that rise to the top of the housing 200 during a thermal event. The pressure-sensitive seals 230 may be positioned in areas where gasses are likely to be released during a thermal event.

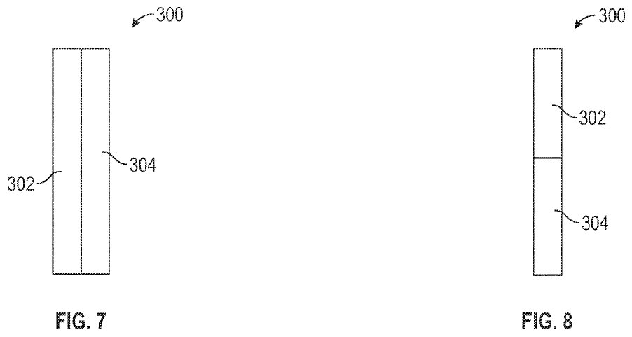

In some embodiments, a seal 230 has a series arrangement such that multiple conditions must be met before rupturing of the seal 230. One example of such a seal 230 is shown in FIG. 7 as a seal 300. The seal 300 includes a first seal layer 302 and a second seal layer 304 overlaid atop of each other. The first seal layer 302 may rupture in response to a first condition, and the second seal layer 304 may rupture in response to a second, different condition. In other embodiments, the seal 300 further includes additional seal layers responsive to other conditions. By overlaying the seal layers 302 and 304, both the first condition and the second condition must be met before the seal 300 will rupture. In this way, the seal 300 provides more strict requirements for rupturing the system, thereby limiting undesired movement of material through an aperture, even if one of the conditions is met.

In other embodiments, a seal 230 has a parallel arrangement such that multiple conditions can each individually trigger rupturing of a seal 230. One example of such a seal 230 is shown in FIG. 8 as a seal 300. The seal 300 includes a first seal layer 302 and a second seal layer 304 positioned adjacent one other. The first seal layer 302 may cover a first portion of an aperture, and the second seal layer 304 may cover a second portion of the aperture. The first seal layer 302 may rupture in response to a first condition, and the second seal layer 304 may rupture in response to a second, different condition. In other embodiments, the seal 300 further includes additional seal layers responsive to other conditions. By exposing both the first seal layer 302 and the second seal layer 304 to the aperture, the first condition, the second condition, or a combination thereof can each cause the seal 300 to rupture. In this way, the seal 300 can respond to a variety of different conditions.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A battery system, comprising:
a housing defining an aperture and an internal volume;
a battery section contained within the internal volume; and
a seal coupled to the housing and reconfigurable from a sealed state to a ruptured state in response to a predetermined condition within the housing,
wherein, in the sealed state, the seal prevents fluid from flowing through the aperture; and
wherein, in the ruptured state, the seal permits the fluid to flow through the aperture.

2. The battery system of claim 1, wherein the seal is configured to change from the sealed state to the ruptured state in response to a pressure differential across the seal exceeding a threshold pressure.

3. The battery system of claim 1, wherein the seal is configured to change from the sealed state to the ruptured state in response to a temperature of the seal exceeding a threshold temperature.

4. The battery system of claim 3, wherein the seal includes a heat-sensitive polymer that is configured to degrade in response to experiencing the threshold temperature.

5. The battery system of claim 3, wherein the seal includes at least one of nylon, polystyrene, polymethyl methacrylate, or a polyolefin.

6. The battery system of claim 1, wherein the seal is configured to change from the sealed state to the ruptured state in response to the seal being exposed to a chemical released from the battery section.

7. The battery system of claim 6, wherein the seal includes an acid-sensitive polymer that is configured to degrade in response to being exposed to an acidic material.

8. The battery system of claim 7, wherein the seal includes at least one of polyethylene or cellulose acetate.

9. The battery system of claim 6, wherein the seal includes an acid-sensitive inorganic material that is configured to degrade in response to being exposed to an acidic material.

10. The battery system of claim 9, wherein the seal includes at least one of calcium carbonate or potassium carbonate.

11. The battery system of claim 1, further comprising a suppressant container fluidly coupled to the aperture such that the aperture supplies fire suppressant from the suppressant container to the internal volume when the seal is in the ruptured state.

12. The battery system of claim 11, wherein the aperture is a first aperture, the seal is a first seal, the predetermined condition is a first predetermined condition, and the housing further defines a second aperture, the battery system further comprising:
a second seal coupled to the housing and reconfigurable from a sealed state to a ruptured state in response to a second predetermined condition within the housing,
wherein, in the sealed state, the second seal prevents the fluid from flowing through the second aperture;
wherein, in the ruptured state, the second seal permits the fluid to flow through the second aperture; and
wherein the suppressant container is fluidly coupled to both the first aperture and the second aperture.

13. The battery system of claim 12, wherein the first predetermined condition is associated with a first portion of the internal volume adjacent the first aperture, and wherein the second predetermined condition is associated with a second portion of the internal volume adjacent the second aperture.

14. The battery system of claim 1, wherein the aperture is positioned to permit fluid from the internal volume to escape the housing when the seal is in the ruptured state.

15. The battery system of claim 1, wherein the predetermined condition is a first predetermined condition, wherein the seal includes a first seal layer responsive to the first predetermined condition and a second seal layer responsive to a second predetermined condition, and wherein the first seal layer overlaps the second seal layer such that the seal is reconfigurable from the sealed state to the ruptured state in response to the seal experiencing both the first predetermined condition and the second predetermined condition.

16. The battery system of claim 1, wherein the predetermined condition is a first predetermined condition, wherein the seal includes a first seal layer responsive to the first predetermined condition and a second seal layer responsive to a second predetermined condition, and wherein the first seal layer and the second seal layer cover different portions of the aperture such that (a) the seal is reconfigurable from the sealed state to the ruptured state in response to the seal experiencing the first predetermined condition and (b) the seal is reconfigurable from the sealed state to the ruptured state in response to the seal experiencing the second predetermined condition.

17. The battery system of claim 1, wherein the aperture is a first aperture, the seal is a first seal, the predetermined condition is a first predetermined condition, and the housing further defines a second aperture, the battery system further comprising:
a second seal coupled to the housing and reconfigurable from a sealed state to a ruptured state in response to a second predetermined condition within the housing,
wherein, in the sealed state, the second seal prevents the fluid from flowing through the second aperture; and
wherein, in the ruptured state, the second seal permits the fluid to flow through the second aperture.

18. The battery system of claim 1, further comprising a controller operatively coupled to the seal and configured reconfigure the seal from the sealed state to the ruptured state.

19. A battery system, comprising:
a housing defining a first aperture, a second aperture, and an internal volume, the first aperture and the second aperture being in fluid communication with the internal volume;
a battery section contained within the internal volume;
a first seal coupled to the housing and extending across the first aperture, the first seal being configured to rupture in response to exposure to an acid to permit flow through the first aperture; and
a second seal coupled to the housing and extending across the second aperture, the second seal being configured to rupture in response to exceeding a threshold temperature to permit flow through the second aperture.

20. A battery system, comprising:
a housing defining an internal volume;
a battery cell;
a fire suppressant supply configured to provide a fire suppressant; and
a seal positioned to fluidly decouple the fire suppressant supply from the internal volume, the seal being configured to rupture in response to contact with a substance released by the battery cell to permit the fire suppressant to enter the internal volume.
